(19) United States
(12) Patent Application Publication
(10) Pub. No.: US 2018/0178182 A1
(43) Pub. Date: Jun. 28, 2018

(54) Method for Producing Microspheres From Coal or Biomass

(71) Applicant: NATIONAL INSTITUTE OF ADVANCED INDUSTRIAL SCIENCE AND TECHNOLOGY, Tokyo (JP)

(72) Inventors: Masato Morimoto, Ibaraki (JP); Qingxin Zheng, Ibaraki (JP); Toshimasa Takanohashi, Ibaraki (JP)

(21) Appl. No.: 15/783,013

(22) Filed: Oct. 13, 2017

(30) Foreign Application Priority Data
Dec. 27, 2016 (JP) 2016-253860
Dec. 27, 2016 (JP) 2016-253945

(51) Int. Cl. B01J 13/04; C10L 5/04; C10L 5/44

(52) U.S. Cl. CPC B01J 13/04; C10L 5/04; C10L 2290/547; C10L 2200/0469; C10L 2250/06; C10L 5/442

(57) ABSTRACT

Coal is extracted with heated and pressurized water, and an extract is collected as microspheres without use of an organic solvent or a surfactant. By this, microspheres containing a hollow spherical particle are produced. Biomass is extracted with heated and pressurized water, and an extract is collected as microspheres without use of an organic solvent or a surfactant.

### TECHNICAL FIELD

The present invention relates to a method for producing spherical microparticles from coal or biomass.

### BACKGROUND ART

Spherical microparticles of organic matters having diameters of several micrometers (hereinafter referred to as microspheres) are widely utilized as raw materials of various porous bodies, structural template materials, carriers and supports for various effective components, and the like in the fields of materials, chemistry, biology, medicine, and the like. Currently known methods for their production can be roughly divided into the following three methods.

(1) Methods in which an emulsion is prepared by dissolving the component of interest in an oil phase or an aqueous phase, and the solvent is then separated/removed to collect microspheres.

(2) Methods in which a polysaccharide is atomized.

(3) Methods in which a sugar such as glucose, xylose, maltose, sucrose, or starch is heated in high-temperature, high-pressure water (Titirici, M. M.; Antonietti, M.; Baccile, N., Hydrothermal carbon from biomass: a comparison of the local structure from poly-to monosaccharides and pentoses/hexoses. Green Chemistry 2008, 10 (11), 1204-1212).

These conventional methods are methods in which microspheres are produced using as a raw material a pure substance such as a macromolecule or sugar, and cannot use complex mixtures containing various components, such as coal and natural materials, for example, wood, or biomass including organic wastes.

### SUMMARY OF THE INVENTION

One aspect of the present invention is to provide a novel method for producing microspheres. Another aspect of the present invention is to develop a novel method for utilizing coal and biomass.

The present inventors discovered that a soluble component can be formed and extracted from coal or biomass by treatment of the coal or biomass with heated and pressurized water, followed by cooling.

One embodiment of the present invention provides a method in which coal or biomass is treated with heated and pressurized water to extract microspheres containing spherical particles.

FIG. 1 shows a schematic diagram showing an example of the reaction apparatus used in the method for producing microspheres from coal or biomass according to one embodiment of the present invention.

In the apparatus in FIG. 1, an extractor provided with a filter 1 is arranged in the lower side in a fluid sand bath. Piping which has a heat exchanger section in the sand bath and which supplies pressurized water heated in the heat exchanger section to the extractor is connected to the upper side of the extractor, and another piping which removes the pressurized water from the extractor after the extraction and guides it to the outside of the fluid sand bath is connected to the lower side of the filter 1 of the extractor. The extract removed to the outside of the fluid sand bath is cooled by a heat exchanger section provided outside the fluid sand bath, and, after collection of a precipitate in a filter 2, the extract is guided to the outside of the system through a back pressure valve. By having such a constitution, water having a set constant high temperature and a set constant high pressure can be allowed to flow in the extractor.

In such an apparatus, by placing coal or biomass on the filter 1 in the extractor and allowing heated and pressurized water to flow therethrough, microspheres containing spherical particles can be generated on a post-filter 2.

A method according to one embodiment of the present invention is a method using only water for producing microspheres, and does not require use of an organic solvent, surfactant, or catalyst. The method is therefore advantageous from the viewpoint of reduction of the environmental load.

Brown coal and peat, which are low-quality, inexpensive coal, are especially suitable as raw materials of microspheres since they have high water contents. By a method according to one embodiment of the present invention, high value-added materials can be stably produced in large amounts from low-quality coals such as brown coal.

Conventionally, utilization of coal in materials chemistry has focused on production of carbon materials and inorganic materials using mineral matter contained in the coal. By a method according to one embodiment of the present invention, an environment-friendly efficient method based on direct conversion of natural organic molecules contained in coal to a single-form material is provided.

By a method according to one embodiment of the present invention, a large amount of microspheres can be stably produced from biomass such as wood which is present in a large amount on the earth, whose utilization as a raw material has been impossible in conventional methods of microsphere production.

By a method according to one embodiment of the present invention, a novel method for utilization of biomass in which the biomass is converted to a high value-added material is provided.

### BRIEF DESCRIPTION OF THE DRAWINGS

FIG. 1 shows a schematic diagram showing the reaction apparatus used in the method for producing microspheres from coal or biomass according to one embodiment of the present invention.

FIG. 2 shows an electron micrograph of microspheres obtained from Loy Yang coal in one embodiment of the present invention.

FIG. 3 shows a transmission electron micrograph of microspheres obtained from Loy Yang coal in one embodiment of the present invention.

FIG. 4 shows an electron micrograph of microspheres obtained from Yun Nan coal in one embodiment of the present invention.

FIG. 5 shows a transmission electron micrograph of microspheres obtained from Yun Nan coal in one embodiment of the present invention.

FIG. 6 shows an electron micrograph of microspheres obtained from red pine in one embodiment of the present invention.

FIG. 7 shows a transmission electron micrograph of microspheres obtained from red pine in one embodiment of the present invention.

FIG. 8 shows an electron micrograph of microspheres obtained from beech in one embodiment of the present invention.

### EMBODIMENTS FOR CARRYING OUT THE INVENTION

For the method for producing microspheres according to one embodiment of the present invention, various coals such as bituminous coal, subbituminous coal, brown coal, and peat can be used.

A method for producing microspheres according to one embodiment of the present invention is applicable to various kinds of biomass. The method is applicable to, for example, solid biomass, woody biomass such as wood, and organic waste-related biomass.

In one embodiment of the present invention, examples of the heated and pressurized water include heated pressurized water at a temperature of about 200 to 380° C. or about 250 to 380° C., and a pressure of about 5 to 30 MPa or about 10 to 25 MPa.

The method for the treatment with the heated and pressurized water is not limited. The coal or biomass may be immersed in the heated and pressurized water by being left to stand, but it is preferred to send the heated pressurized water to the coal or biomass to immerse the coal or biomass in the heated pressurized water. The conditions for sending the liquid is not limited, and examples thereof include 0.1 mL/min. to 10 mL/min., or 0.5 mL/min. to 5 mL/min.

The time for the treatment with the heated and pressurized water is not limited as long as it is sufficient for obtaining microspheres having a predetermined particle size. Examples of the processing time include 0.5 to 10 hours, or 1 to 5 hours.

The treatment with the heated and pressurized water may be followed by a step of separating microspheres. Examples of such a step include a step of separating microspheres using a filter which allows passing of particles having a particle size of about 0.1 to 100 micrometers but does not allow passing of particles having a particle size of not less than 100 micrometers. By including this filtering step, the microspheres can be separated from particles having larger particle sizes, and impurities.

By a method according to one embodiment of the present invention, microspheres having a particle size of about 0.1 to 10 micrometers, about 0.1 to 50 micrometers, or about 0.1 to 100 micrometers can be obtained.

The microspheres obtained by a method according to one embodiment of the present invention, especially those obtained by treating coal with heated and pressurized water, may contain hollow spherical particles. The diameter of the hollow hole of the hollow spherical particle is half the diameter of the particle, for example, about 0.05 to 5 micrometers, about 0.05 to 25 micrometers, or about 0.05 to 50 micrometers.

Hollow particles can be separated from non-hollow particles by, for example, carrying out centrifugation operation in a state where the particles are dispersed in a liquid, by taking advantage of the fact that the hollow particles have smaller specific gravities than non-hollow particles.

The microspheres obtained have components of, for example, 50 to 80% carbon, 2 to 10% hydrogen, and 10 to 40% oxygen in terms of the element composition. The microspheres may contain nitrogen, sulfur, and/or the like, and their ratios may be from 1% to below the detection limit.

### EXAMPLES

Preferred embodiments of the present invention are described below by way of Examples. However, the present invention is not limited to the embodiments in these Examples.

### Example 1

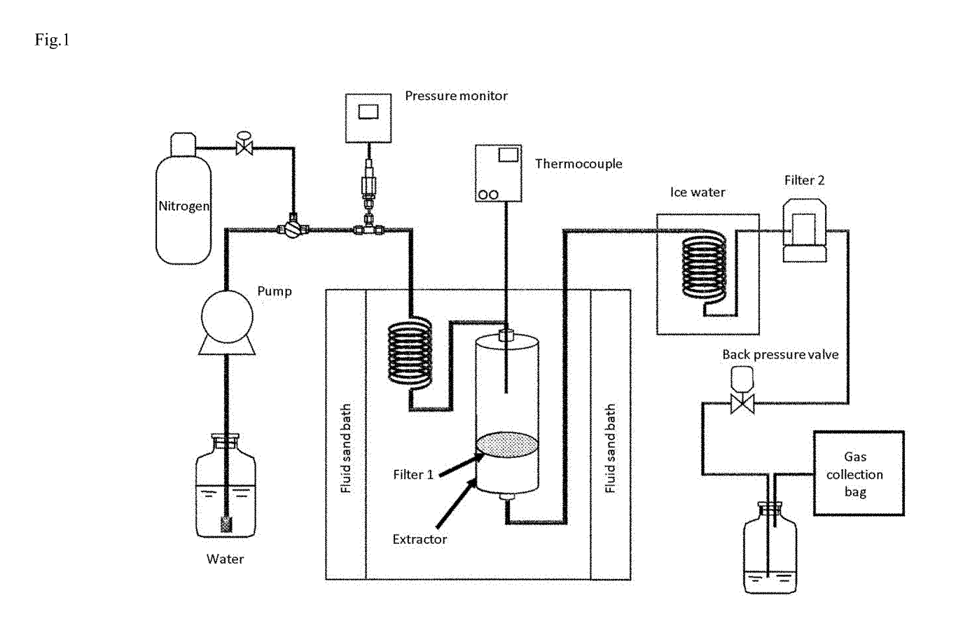

As a raw material, Loy Yang coal (LY), which is an Australian brown coal, was used. On a metal filter (filter 1 in FIG. 1; pore size, 0.5 μm) arranged in a semi-batch extractor having an internal capacity of 20 mL, 2 g of LY was placed, and water was sent thereto at 1 mL/min. The pressure in the system was kept at 20 MPa using a back pressure valve, and the extractor was placed in a fluid sand bath preheated at 350° C. By this operation, components in the brown coal and degradation products soluble in water at 350° C. at 20 MPa are allowed to pass through the filter in the extractor, and eluted to the outside of the extractor. After the temperature in the system reached 350° C., the temperature was kept for 90 minutes, and the extractor was then removed from the sand bath for air cooling. The components that were eluted to the outside of the extractor and then precipitated were collected using a post-filter (filter 2 in FIG. 1; pore size, 0.5 μm).

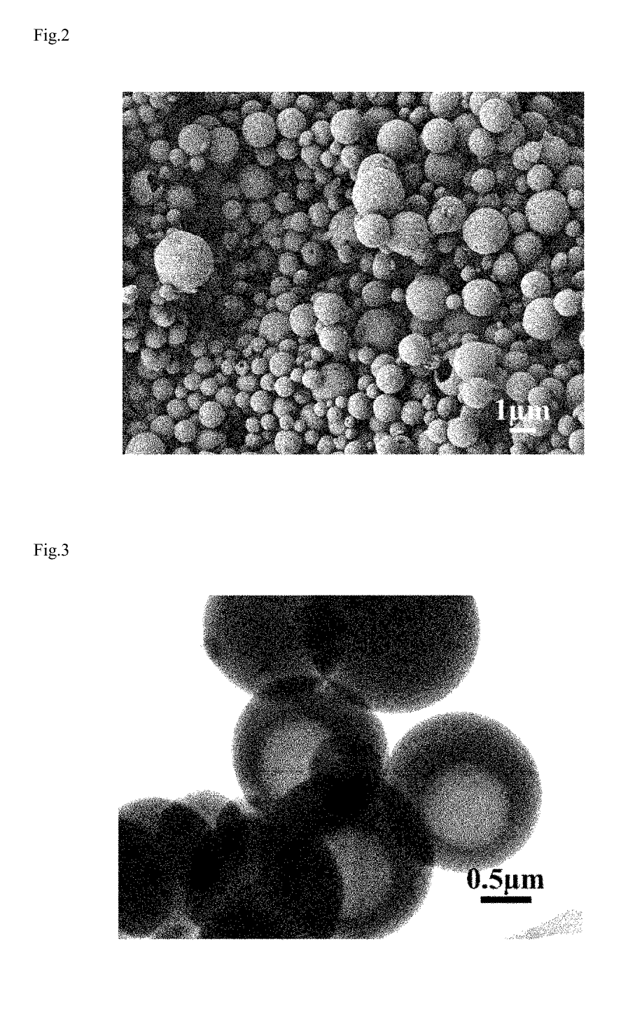

The yield of the collected product was 23%. FIG. 2 shows an electron micrograph of the product collected with the post-filter. It can be seen that the product is uniformly spherical particles having diameters of about 0.5 to 2 μm. It can be seen that the product partially contains broken particles, and has pores therein. FIG. 3 shows a transmission electron micrograph. Gray parts were found in black spherical particles. The gray parts correspond to the faint color in the transmission image, which appears due to the presence of the pores. The element composition obtained by elementary analysis was 73.2% carbon, 6.9% hydrogen, 0.5% nitrogen, 0.2% sulfur, 19% oxygen, and 0.6% ash.

### Example 2

As a raw material, Yun Nan coal (YN), which is Chinese brown coal, was used. On a metal filter (filter 1 in FIG. 1; pore size, 0.5 μm) arranged in a semi-batch extractor having an internal capacity of 20 mL, 2 g of YN was placed, and water was sent thereto at 1 mL/min. The pressure in the system was kept at 20 MPa using a back pressure valve, and the extractor was placed in a fluid sand bath preheated at 350° C. By this operation, components in the brown coal and degradation products soluble in water at 350° C. at 20 MPa are allowed to pass through the filter in the extractor, and eluted to the outside of the extractor. After the temperature in the system reached 350° C., the temperature was kept for 90 minutes, and the extractor was then removed from the sand bath for air cooling. The components that were eluted to the outside of the extractor and then precipitated were collected using a post-filter (filter 2 in FIG. 1; pore size, 0.5 μm).

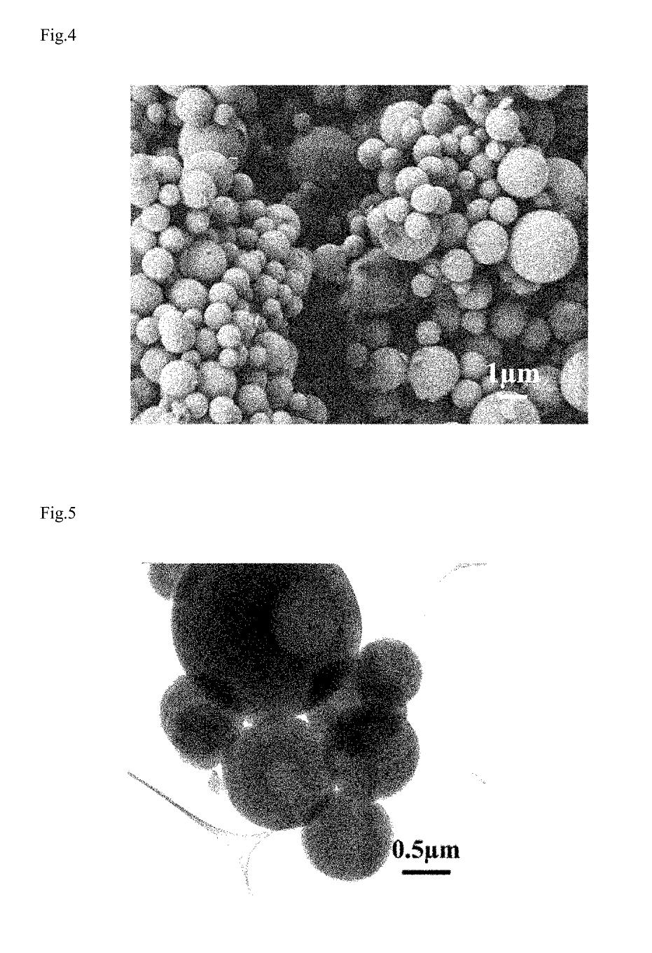

FIG. 4 shows an electron micrograph of the solid collected with the post-filter. FIG. 5 shows a transmission electron micrograph. It can be seen that the product is spherical particles having diameters of 0.5 to 2.5 μm having pores therein. The yield of the hollow spherical particles was 38%, and the element composition was 76.8% carbon, 8.0% hydrogen, 1.2% nitrogen, 0% sulfur, 14% oxygen, and 0.4% ash.

### Example 3

As a material, Japanese red pine was used. On a metal filter (filter 1 in FIG. 1; pore size, 0.5 μm) arranged in an extractor having an internal capacity of 20 mL, 2 g of red pine chip was placed, and water was sent thereto at 1 mL/min. The pressure in the system was kept at 10 MPa using a back pressure valve, and the extractor was placed in a fluid sand bath preheated at 300° C. By this operation, components in the red pine and degradation products soluble in water at 300° C. at 10 MPa are allowed to pass through the filter in the extractor, and eluted to the outside of the extractor. After the temperature in the system reached 300° C., the temperature was kept for 60 minutes, and the extractor was then removed from the sand bath for air cooling. The components that were eluted to the outside of the extractor and then precipitated were collected using a post-filter (filter 2 in FIG. 1; pore size, 0.5 μm ).

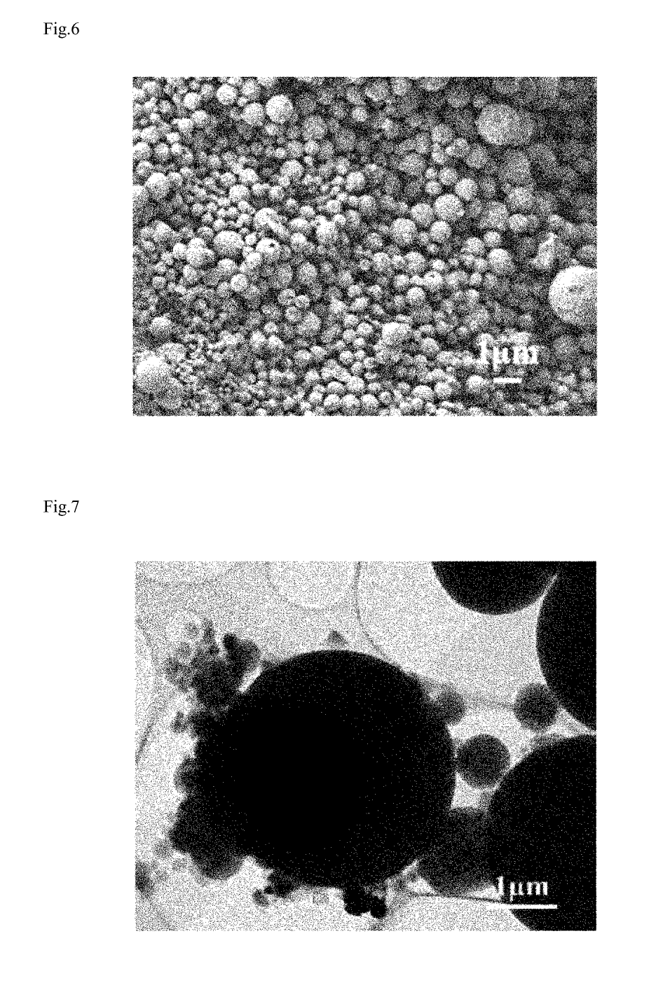

The yield of the collected product was 15%. FIG. 6 shows an electron micrograph of the product collected with the post-filter. It can be seen that the product is uniformly spherical particles having diameters of about 0.5 to 5 μm. FIG. 7 shows a transmission electron micrograph. It can be seen that the particles are almost complete spheres. The element composition obtained by elementary analysis was 69.1% carbon, 5.6% hydrogen, 0% nitrogen, 0% sulfur, and 25.3% oxygen. cl Example 4

As a material, Japanese beech was used. On a metal filter (filter 1 in FIG. 1; pore size, 0.5 μm) arranged in an extractor having an internal capacity of 20 mL, 2 g of beech chip was placed, and water was sent thereto at 1 mL/min. The pressure in the system was kept at 10 MPa using a back pressure valve, and the extractor was placed in a fluid sand bath preheated at 300° C. By this operation, components in the beech and degradation products soluble in water at 300° C. at 10 MPa are allowed to pass through the filter in the extractor, and eluted to the outside of the extractor. After the temperature in the system reached 300° C., the temperature was kept for 60 minutes, and the extractor was then removed from the sand bath for air cooling. The components that were eluted to the outside of the extractor and then precipitated were collected using a post-filter (filter 2 in FIG. 1; pore size, 0.5 μm).

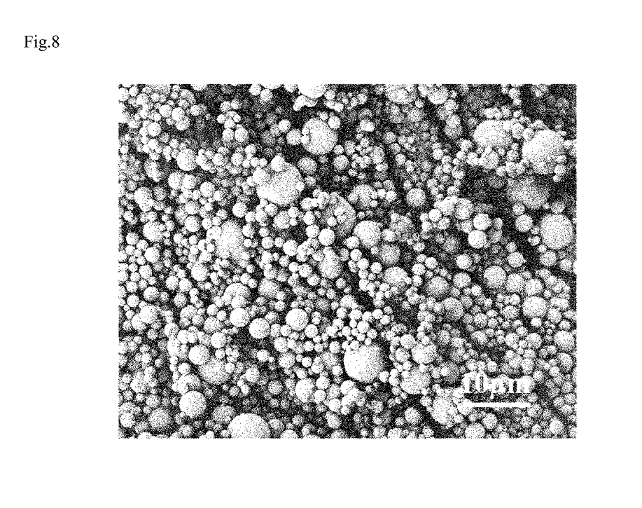

The yield of the collected product was 29.5%. FIG. 8 shows an electron micrograph of the solid collected with the post-filter. It can be seen that the product is spherical particles having diameters of 0.5 to 5 μm. The element composition obtained by elementary analysis was 62.3% carbon, 4.4% hydrogen, 0% nitrogen, 0% sulfur, and 33.3% oxygen.

Although preferred embodiments for the present invention are described, it is evident to those skilled in the art that the preferred embodiments can be modified. It is meant that the present invention can also be specifically expressed by methods other than those described in detail in the present description. Accordingly, the present invention encompasses the object of Claims and all modifications included within the scope thereof.

The present application claims priority to Japanese Patent Application Nos. 2016- 253860 and 2016-253945, and their contents are hereby incorporated by reference.

1. A method for producing spherical microparticles, comprising treating coal or biomass with heated and pressurized water.

2. The method according to claim 1, wherein said spherical microparticles contain a hollow spherical particle.

3. The method according to claim 1, comprising carrying out said treatment in water at a temperature of 200° C. to 380° C. and a pressure of 5 MPa to 30 MPa.

4. The method according to claim 1, wherein said spherical microparticles are spherical microparticles having a particle size of 0.1 micrometers to 100 micrometers.

5. The method according to claim 1, further comprising separating the spherical microparticles.

6. The method according to claim 1, wherein the spherical microparticles have an element composition of 50% to 80% carbon, 2% to 10% hydrogen, and 10% to 40% oxygen.
